(19) United States
(12) Patent Application Publication
(10) Pub. No.: US 2010/0182117 A1
(43) Pub. Date: Jul. 22, 2010

(54) High Frequency Magnetic Current Transducer

(76) Inventors: Xinke Wu, Eastcom City (CN); Guichao Hua, Hangzhou (CN); Xun Huang, Eastcom City (CN)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/686,657

(22) Filed: Jan. 13, 2010

(30) Foreign Application Priority Data
Jan. 22, 2009 (CN) 200910095575.5

(51) Int. Cl. H01F 27/29

(52) U.S. Cl. 336/192

(57) ABSTRACT

A pulse current transducer including at least one open core, an armature, together with the at least one open core form a closed magnetic circuit, a winding wound around the at least one open core, at least one signal output pin connected to the at least one open core, and a conducting strip between the armature and the at least one open core.

### CROSS-REFERENCE TO RELATED APPLICATIONS

This application claims priority of Chinese Patent Application No. 200910095575.5 filed Jan. 22, 2009, which is incorporated herein by reference.

### TECHNICAL FIELD

Exemplary embodiments of the present invention generally relate power supply technology, and, more specifically, to a high frequency pulse current transducer (CT) that may be used in a switching power supply.

### BACKGROUND OF THE INVENTION

A high frequency pulse current transducer is widely used in a switching power supply. It is generally used as a control, drive, or protection signal in detecting the switching-frequency pulsed current. A pulse current transducer commonly uses a magnetic core, such as a toroid core (or ring-core), or an E core with bobbin, with a signal winding (secondary winding) wound around the core or the bobbin. The primary conductor (current) passes through the magnetic ring or wound around the bobbin. Then the pulse current signal needed is obtained from the secondary winding. FIG. 1 discloses a prior art diagram of such a pulse current transducer. As illustrated, a core 10 is provided which is a toroid core, or ring-core. A signal winding 13 winds around the ring-core 10. A primary conductor 12 passes through the ring-core 10. The pulse current signal is obtained from the signal winding in this way.

FIG. 2A is another prior art representation of a pulse current transducer, showing the current transducer in an exploded view. As illustrated, a pair of E-cores 15 and a bobbin 16 are included. The signal winding 13 is wound around the bobbin 16, and then a primary conducting foil 18, such as made from a copper foil, after being pre-formed, is placed around the winding 13. The bobbin 16 is inserted into a center column of a first E-core 15. Finally, the second E-core 15 is inserted into the bobbin 16 to form a closed magnetic circuit with the first E-core 15. FIG. 2B illustrates two prior art representations of the pulse current transducer. As further illustrated, a sample current is obtained from the conducting foil 18 and transformer pins 20 are provided.

Constructing the above mentioned pulse current transducers is complicated. When the transducer uses a toroid core, the turns of the signal winding in the transducer is up to several hundred, where the winding can only be made by hand and the cost is very high. When the transducer uses an E core with a bobbin, although the signal winding is relatively simple compared with a winding using a toroid core, it is still difficult to deal with the primary conductor since it is usually pre-formed in a special way. Moreover, the assembly must be done in a 3-dimensional mode. If automated production is desired, it requires very sophisticated production equipment which is very expensive. Therefore, manual assembly is still the preferred approach to assembling such transducers. In order to reduce labor cost, manufacturers would benefit from a revised signal winding and the assembly process for pulse current transducers wherein automated production would be more feasible financially.

### SUMMARY OF THE INVENTION

Exemplary embodiments of the present invention intend to solve the drawbacks of the prior art by providing a pulse current transducer with simpler structure to simplify the manufacturing process and reduce the manufacturing cost. In one embodiment a pulse current transducer comprises at least one open core and an armature which together with the at least one open core form a closed magnetic circuit. A winding wound around the at least one open core, at least one signal output pin connected to the at least one open core, and a conducting strip between the armature and the at least one open core are also disclosed.

In another exemplary embodiment, a pulse current transducer having a signal channel sampling and dual channel signal output comprises at least one open core and an armature which together with the at least one open core form a closed magnetic circuit. A first winding wound around the at least one open core and a second winding wound around the armature, at least one signal output pin connected to the at least one open core and/or the armature, and a conducting strip between the armature and the at least one open core are also disclosed.

### BRIEF DESCRIPTION OF THE FIGURES

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 is a prior art diagram of a transducer with ring-core;

FIG. 2A is an exploded view of a prior art diagram of a transducer with E-cores and a bobbin;

FIG. 2B is an axonometric diagram from a selected angle of a first and a second transducer with E-cores and a bobbin;

FIG. 3A is a diagram of an simple bar;

FIG. 3B is a diagram of an I-bar;

FIG. 3C is a diagram of a magnetic core using an I-bar;

FIG. 4A is an exploded view of a current transducer using a first I-bar as a magnetic core and a second I-bar as an armature;

FIG. 4B is a diagram of the current transducer illustrated in FIG. 4A in an operational configuration;

FIG. 5A is an exploded view of another exemplary embodiment of a current transducer using an I-bar magnetic core and a slice armature;

FIG. 5B is a diagram of the current transducer illustrated in FIG. 5A in an operational configuration;

FIG. 6A is an exploded view of another exemplary embodiment of a current transducer having the signal output pin connected to the I-core in a SMD package;

FIG. 6B is a diagram of the current transducer illustrated in FIG. 6B in an operational configuration;

FIG. 7A is an exploded view of another exemplary embodiment of a current transducer having two I-bars as magnetic cores, each having two outputs and signal windings.

FIG. 7B is a diagram of the current transducer illustrated in FIG. 7A in an operational configuration;

FIG. 8A is a diagram of an integrated dual channel current transducer; and

FIG. 8B is a diagram of the current transducer illustrated in FIG. 8A in an operational configuration.

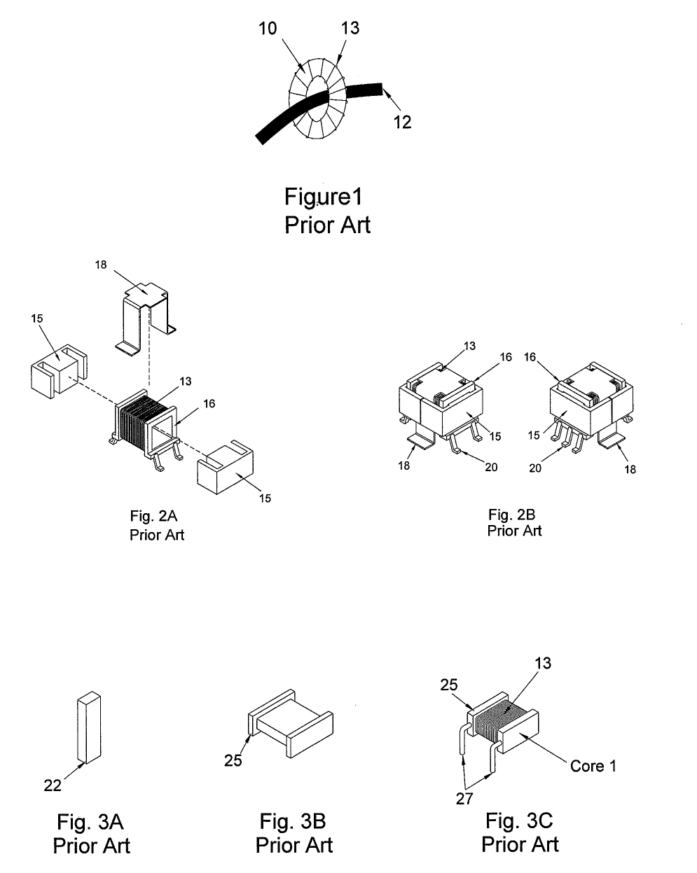

### DETAILED DESCRIPTION

Reference will be made below in detail to exemplary embodiments of the invention, examples of which are illustrated in the accompanying drawings. Wherever possible, the same reference numerals used throughout the drawings refer to the same or like parts. Several embodiments of the invention are discussed below.

Generally, exemplary embodiments of the present invention provide for a pulse current transducer which includes one transducer or more in basically a same configuration as the first one. Each transducer has an open slice or I-type core and an I-type armature which jointly form a closed magnetic circuit. The core actually can be any form of open-structure, in a preferred form of bar, or disk-shape or I-type core.

The I-type core has a secondary winding which is wound around the core without a bobbin where the signal output pins are plugged into the core directly. Without the bobbin, exemplary embodiments of the invention are not limited in a winding process by a number of turns of the winding. Thus, a size of the current transducer may be reduced, and the structure simplified, making the process more suitable for automated production. The winding winds around the core, where it is easy to be wound in an automated production line. An armature is provided. The armature can be any form of structure which can form a closed magnetic circuit with the core, in a preferred form of bar, or disk-shape, or I-type core. In an exemplary embodiment, the armature also has a signal winding which forms another sampling method for dual signal outputs application.

A primary conductor is set between the armature and the core. The primary conductor may be any form of structure, such as but not limited to a slice core (or flat plate), a U-shape plate and/or an L-shape plate to form a magnetic circuit to increase the transducer's inductance, reduce the leakage inductance as well as the interference of external magnetic field on the transducer. This conductor can be any metals with low resistance, and copper or silver sheets are preferred.

The primary conductor is connected to the sampling current loop so that the current passes through the conductor and the signal represents a sensed current which is obtained at the signal output pins. The signal output pins are attached at the basic core in using either a SMD or Through-hole technique. Since there is no bobbin used in this invention, it is very simple in manufacturing with low cost.

When in used, any number of transducers may be stacked from the top to the bottom to constitute an integrated dual-channel current transducer or multi-channel current transducer, with adjacent two channels sharing a common armature to further simplify the transducer structure.

FIGS. 3A and 3B depict two exemplary embodiments of a core. The core can be any form of an open-structure core. One preferred embodiment is in a form of a simple bar 22, as illustrated in FIG. 3A. Another embodiment is slice-shape or “I”-shape core 25 as illustrated in FIG. 3B. FIG. 3C illustrates an I-shape core 25 having a winding 13 around the I-shape core 25, and signal output pins 27 extending from the I-shape core 25.

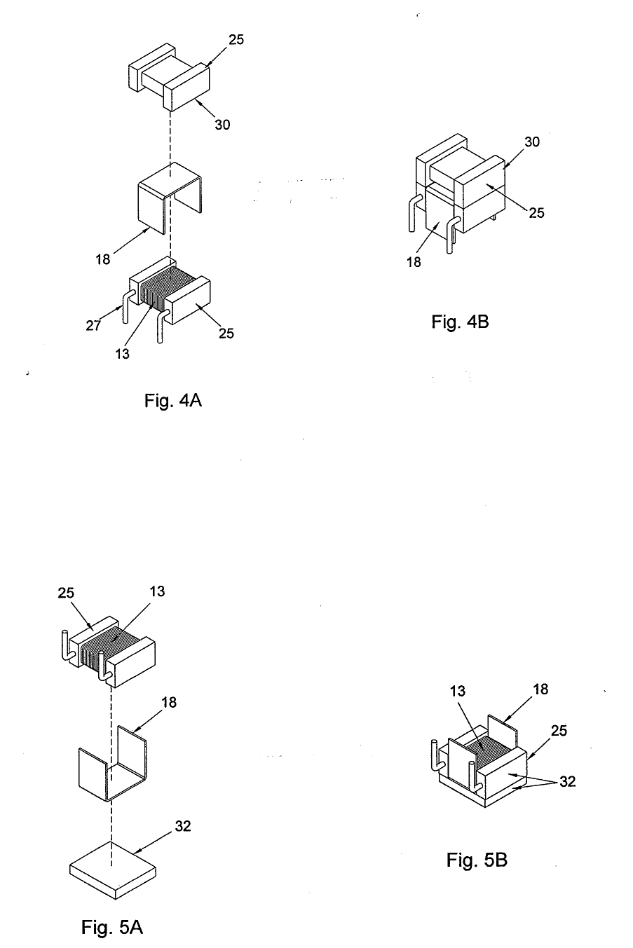

FIGS. 4A and 4B illustrate another exemplary embodiment of a current transducer where a single channel sensing single signal output circuit is used, including a pair of planar I-shape magnetic cores 25 where the second core 25 functions as an armature 30. The first I-core 25 is wound around by the winding 13, and signal output pins 27 are connected through the first I-core 25 using a through-hole mounting technique and/or surface mount technology (“SMT”) resulting in a surface mount device (“SMD”), either technology which those skilled in the art will recognize. The I-core 25 and the armature 30 are stacked from top to bottom to form a closed magnetic circuit. A U-type foil 18, or a primary conductor, is set between the first I-core 25 and the armature 30. The U-type foil 18 is associated with a current sensing position where the current is needed to be sensed.

FIGS. 5A and 5B illustrate another embodiment of a current transducer using a single channel sensing single signal output circuit. A primary difference between the current transducer illustrated FIGS. 4A and 4B and FIGS. 5A and 5B are that the armature 32 has a slice core configuration in FIGS. 5A and 5B as oppose to the I-core configuration as disclosed in FIGS. 4A and 4B.

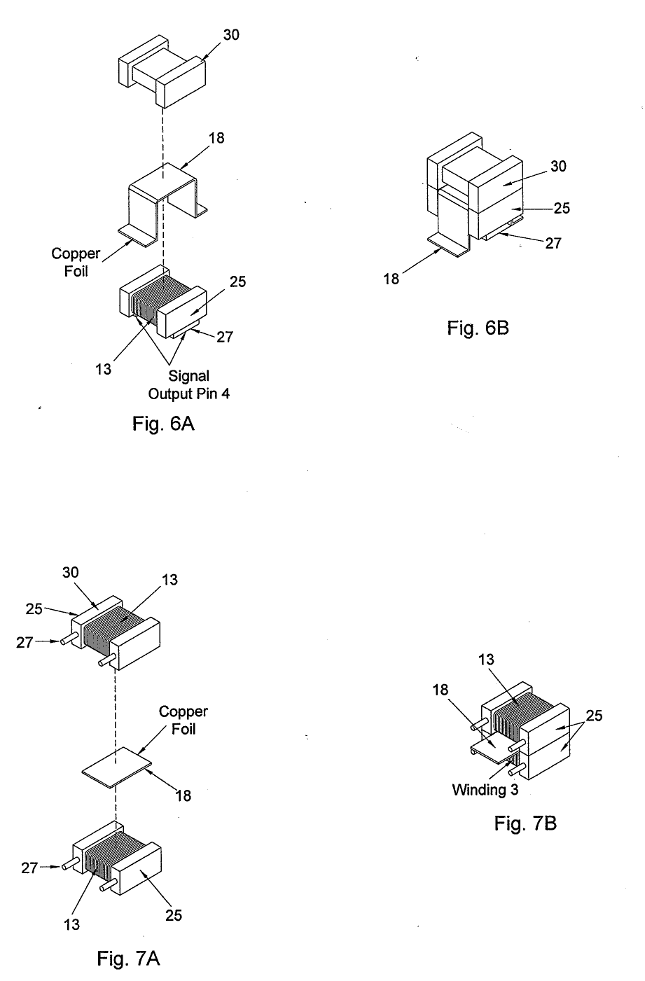

FIGS. 6A and 6B illustrate another embodiment of a current transducer using a single channel sensing single signal output circuit. The only difference between the embodiments disclosed in FIGS. 4A and 4B to those disclosed in FIGS. 6A and 6B is that the signal output pins 27 have another configuration and are connected at another location on the I-core 25 using a SMT technique resulting the in the I-core 25 and signal output pins 27 being part of a SMD.

FIGS. 7A and 7B disclose another embodiment of a current transducer using a single channel sensing dual signal outputs circuit. A difference between the embodiment disclosed in FIGS. 7A and 7B when compared to the embodiment disclosed in FIGS. 4A and 4 is that in FIGS. 7A and 7B, the armature 30 is also wound by the winding 13, and a pair of signal output pins 27 are set on it, and the conducting strip 18 has a slice configuration.

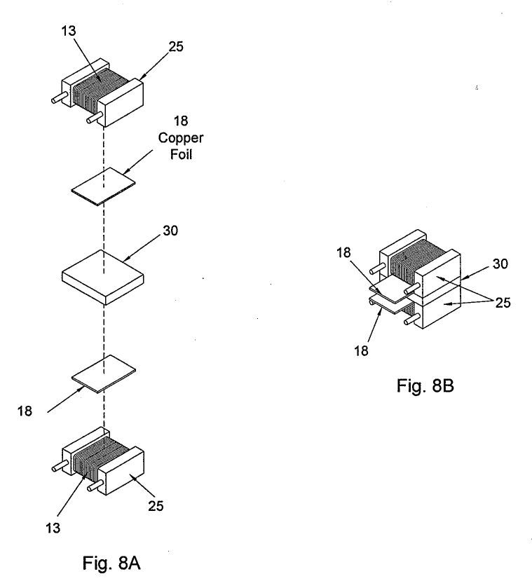

FIGS. 8A and 8B disclose an embodiment of integrated dual channel transducer. A pair of I-shape cores 25 are provided, each with wound around by a first winding 13 and a second winding 13, respectfully. A slice-shape armature 30 is positioned between a pair of primary conducting strips 18. A pair of signal output pins 27 are connected to each I-core 25 using a through-hole mode, or technique. The first core 25, the primary or first conducting strip 18, the armature 30, the second conducting strip 18, and the second I-core 25 are stacked one by one from top to bottom. In this manner, the first I-core 25, the first conducting strip 18, and the armature 30 form a first current transducer. The second I-core 25, the second conducting strip 18, the armature 30, the second winding 13 and the signal output pins 27 form a second current transducer. The two channels of current transducers share a common armature 30 to form an integrated dual-channel current transducer.

While the invention has been described with reference to various exemplary embodiments, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A pulse current transducer comprising:
at least one open core;
an armature, together with the at least one open core form a closed magnetic circuit;
a winding wound around the at least one open core;
at least one signal output pin connected to the at least one open core; and
a conducting strip between the armature and the at least one open core.

2. The pulse current transducer according to claim 1, wherein the at least one open core is configured as a bar, a slice-shape bar, and/or an I-shape bar.

3. The pulse current transducer according to claim 1, wherein the armature is configured as a bar, a slice-shape bar, and/or an I-shape bar.

4. The pulse current transducer according to claim 1, wherein the conducting strip is configured as a flat plate, a U-shape plate, and/or a L-shape plate.

5. The pulse current transducer according to claim 1, wherein the conducting strip is comprised of a copper foil and/or a silver foil.

6. The pulse current transducer according to claim 1, wherein the signal output pin is connected to the core with surface mount technology and/or through-hole mode technology.

7. A pulse current transducer having a signal channel sampling and dual channel signal output comprising:
at least one open core;
an armature, together with the at least one open core form a closed magnetic circuit;
a first winding wound around the at least one open core and a second winding wound around the armature;
at least one signal output pin connected to the at least one open core and/or the armature; and
a conducting strip between the armature and the at least one open core.

8. The pulse current transducer according to claim 7, wherein the at least one open core is configured as a bar, a slice-shape bar, and/or an I-shape bar.

9. The pulse current transducer according to claim 7, wherein the armature is configured as a bar, a slice-shape bar, and/or an I-shape bar.

10. The pulse current transducer according to claim 7, wherein the conducting strip is configured as a flat plate, a U-shape plate, and/or a L-shape plate.

11. The pulse current transducer according to claim 7, wherein the conducting strip is comprised of a copper foil and/or a silver foil.

12. The pulse current transducer according to claim 7, wherein the at least one signal output pin is connected to the core and/or armature with surface mount technology and/or through-hole mode technology.

13. The pulse current transducer according to claim 1, further comprising a second pulse current transducer as claimed in claim 1 stacked with the first pulse current transducer to form an integrated dual channel current transducer and/or a multi channel current transducer.

14. The pulse current transducer according to claim 13, wherein the first pulse current and the second pulse current transducer share a common armature.
